(19) United States
(12) Patent Application Publication
(10) Pub. No.: US 2024/0243520 A1
(43) Pub. Date: Jul. 18, 2024

(54) TAMPER RESISTANT CONNECTOR ASSEMBLY

(71) Applicant: Crown Equipment Corporation, New Bremen, OH (US)

(72) Inventors: Vern I. Woodruff, III, Kenton, OH (US); Aaron Schmitz, New Bremen, OH (US); Collin Will, Fort Jennings, OH (US); Kurt Meiring, Osgood, OH (US); Dean Winner, Celina, OH (US)

(21) Appl. No.: 18/534,883

(22) Filed: Dec. 11, 2023

Related U.S. Application Data
(60) Provisional application No. 63/479,600, filed on Jan. 12, 2023.

(51) Int. Cl. H01R 13/627; H01R 13/639

(52) U.S. Cl. CPC H01R 13/6275; H01R 13/6397

(57) ABSTRACT

A tamper resistant connector assembly is provided for restricting access to a latch assembly of a plug that is connected to equipment. While the tamper resistant connector assembly is assembled to the plug, the plug cannot be released from the equipment.

### CROSS REFERENCE TO RELATED APPLICATION

This application claims the benefit of U.S. Provisional Patent Application Ser. No. 63/479,600, filed Jan. 12, 2023, entitled “TAMPER RESISTANT CONNECTOR ASSEMBLY”, attorney docket 2208/CRN 1055 MA, the entire disclosure of which is hereby incorporated by reference herein.

### FIELD

The present disclosure relates to tamper resistant connector assemblies for restricting access to a connector latch assembly that is used to releasably couple a plug to a plug port of an equipment.

### BACKGROUND

Equipment, such as electrical equipment, may include a plug for supplying power to the equipment. Plugs of this type may include a latch assembly that can be actuated by a user to release the plug from the equipment.

### SUMMARY

In accordance with one aspect, a combination is provided comprising a plug and a tamper resistant connector assembly. The plug provides a connection to an equipment and comprises a front side for connection to a cable, a back side for connection to the equipment, and a latch assembly. The equipment may be a display device that may include a display screen or graphical user interface (GUI). The equipment, the plug and the connector assembly may be used on a material handling vehicle, such as a forklift truck. The plug may comprise a first side comprising the latch assembly. The first side may be different from the front side and the back side of the plug, wherein the first side may be an upper side of the plug. The latch assembly is movable between a locked position in which the plug cannot be released from the equipment, and an unlocked position in which the plug can be released from the equipment. The tamper resistant connector assembly is provided for restricting access to the latch assembly of the plug and comprises a first structure, a second structure, and fastener structure. The first structure is engageable with the plug proximate to the latch assembly and restricts access to the latch assembly such that the latch assembly is not able to be moved from the locked position to the unlocked position when the first structure is engaged with the plug. The second structure is engageable with the first structure such that the first structure is not able to be disengaged from the plug when the second structure is engaged with the first structure. The fastener structure is configured to lock the second structure in engagement with the first structure.

In an embodiment, the first structure is engaged with the plug proximate to the latch assembly and restricts access to the latch assembly such that the latch assembly is not able to be moved from the locked position to the unlocked position. In this embodiment, the second structure is engaged to the first structure such that the first structure is not able to be disengaged from the plug, and the fastener structure locks the second structure in engagement with the first structure.

The first and second structures may be separate structures.

The first structure may be removably engageable with the plug, wherein, when the first structure is not engaged with the plug, access to the latch assembly is permitted such that the latch assembly is able to be moved from the locked position to the unlocked position.

The second structure may be lockably engageable to the first structure and the fastener structure may lockably engage the second structure to the first structure. The second structure may be positionable in first and second positions relative to the first structure. The first position of the second structure may comprise an attached position where the second structure is attached to the first structure, and the second position of the second structure may comprise a detached position where the second structure is detached from the first structure. The fastener structure may selectively lock the second structure in the first position.

When the fastener structure is locking the second structure in engagement to the first structure, the fastener structure may be secured to the first structure and create a stop that prevents the second structure from moving from the first position to the second position.

The second structure may include an extension portion for overlapping at least a part of the first structure while the second structure is in the first position, wherein the extension portion may act as a stop to prevent the first structure from being removed from the plug. The first structure may comprise a groove for receiving the extension portion. The groove of the first structure and the extension portion of the second structure may be correspondingly tapered. The tapered shapes of the groove and the extension portion may prevent the first structure from being pulled away from the plug and/or serve as a positioning aid to ensure that the second structure is installed in the groove in the correct orientation. The extension portion may include a lip for extending over a front face of the first structure to prevent the first structure from being disengaged from the plug.

The fastener structure may be a removable structure comprising at least one of a screw, bolt, or pin. The fastener structure may require special tooling to actuate the fastener structure to militate against undesirable tampering with the connector assembly by an unauthorized person.

The fastener structure may be receivable in openings formed in the respective first and second structures.

The plug may include an attachment portion with an opening and the first structure may include an insertion portion for being received by the opening of the attachment portion of the plug, wherein the attachment portion may comprise an arc-shaped or U-shaped attachment piece. The attachment portion may extend outwardly from the first side of the plug. The opening may be defined between the arc-shaped or U-shaped attachment piece and an arm member of the latch assembly. The placement of the insertion portion in the opening defined by the attachment portion may militate against the first structure from being lifted, e.g., in an upward direction, away from the plug. Alternatively or additionally, when the first structure is engaged with the plug, a first side of the first structure, which may be an upper side of the first structure, abuts against or closely encounters a ledge of the equipment and a second side of the first structure, which is opposite to the first side of the first structure and which may be a lower side of the first structure, abuts or closely encounters the first side of the plug. Hence, while in the engaged position, the first structure may be positioned between and abuts or closely encounters the equipment ledge and the plug, which militates against the first structure from being lifted, e.g., in an upward direction, away from the plug. The first structure may comprise a cutout portion for receiving the attachment portion of the plug.

The latch assembly may comprise an arm member and the first structure may comprise blocking structure for restricting access to the arm member. The blocking structure may comprise a pair of blocking elements that extend from a body portion of the first structure toward the plug on respective first and second lateral sides of the arm member when the first structure is engaged with the plug. The blocking structure may block access to the lateral sides of the arm member when the first structure is engaged with the plug. The blocking structure may comprise a first blocking element of the first structure and a second blocking element of the second structure, wherein the first and second blocking elements may enclose an arm member of the latch assembly within the cutout portion of the first structure. The blocking structure may prevent the latch assembly from being moved from a locked position to an unlocked position when the first structure is engaged with the plug.

The first structure may include an insertion portion and the second structure may comprise a notch for receiving the insertion portion of the first structure. The notch may provide an alignment aid for the insertion portion so that the first structure is properly aligned with the second structure.

In accordance with another aspect, a tamper resistant connector assembly is provided for selectively allowing and restricting access to a latch assembly of a plug that provides a connection to an equipment. The equipment may be a display device that may include a display screen or graphical user interface (GUI). The equipment, the plug and the connector assembly may be used on a material handling vehicle, such as a forklift truck. The latch assembly is movable between a locked position in which the plug cannot be released from the equipment, and an unlocked position in which the plug can be released from the equipment. The tamper resistant connector assembly comprises a first structure, a second structure, and fastener structure. The first structure is removably engageable with the plug proximate to the latch assembly. When the first structure is engaged with the plug, access to the latch assembly is restricted such that the latch assembly is not able to be moved from the locked position to the unlocked position. When the first structure is not engaged with the plug, access to the latch assembly is permitted such that the latch assembly is able to be moved from the locked position to the unlocked position. The second structure is positionable in first and second positions relative to the first structure. While the second structure is in the first position, the second structure is engaged with the first structure such that the first structure is not able to be disengaged from the plug. While the second structure is in the second position, the first structure is able to be disengaged from the plug. The fastener structure is configured to selectively lock the second structure in the first position.

The first and second structures may be separate structures.

The first position of the second structure may comprise an attached position where the second structure is attached to the first structure, and the second position of the second structure may comprise a detached position where the second structure is detached from the first structure.

The fastener structure may be a removable structure comprising at least one of a screw, bolt, or pin. The fastener structure may require special tooling to actuate the fastener structure to militate against undesirable tampering with the connector assembly by an unauthorized person.

When the fastener structure is locking the second structure in engagement to the first structure, the fastener structure may be secured to the first structure and create a stop that prevents the second structure from moving from the first position to the second position.

The latch assembly may comprise an arm member and the first structure may comprise blocking structure for restricting access to the arm member. The blocking structure may comprise a pair of blocking elements that extend from a body portion of the first structure toward the plug on respective first and second lateral sides of the arm member when the first structure is engaged with the plug. The blocking structure may block access to the lateral sides of the arm member when the first structure is engaged with the plug. The blocking structure may comprise a first blocking element of the first structure and a second blocking element of the second structure, wherein the first and second blocking elements may enclose an arm member of the latch assembly within a cutout portion of the first structure. The blocking structure may prevent the latch assembly from being moved from a locked position to an unlocked position when the first structure is engaged with the plug.

The second structure may include an extension portion for overlapping at least a part of the first structure while the second structure is in the first position, wherein the extension portion may act as a stop to prevent the first structure from being removed from the plug. The first structure may comprise a groove for receiving the extension portion. The groove of the first structure and the extension portion of the second structure may be correspondingly tapered. The tapered shapes of the groove and the extension portion may prevent the first structure from being pulled away from the plug and/or serve as a positioning aid to ensure that the second structure is installed in the groove in the correct orientation. The extension portion may include a lip for extending over a front face of the first structure to prevent the first structure from being disengaged from the plug.

The first structure may include an insertion portion that is received by an opening defined by an attachment portion of the plug. The attachment portion may comprise an arc-shaped or U-shaped attachment piece. The attachment portion may extend outwardly from a first side of the plug. The opening may be defined between the arc-shaped or U-shaped attachment piece and an arm member of the latch assembly. The placement of the insertion portion in the opening defined by the attachment portion may militate against the first structure from being lifted, e.g., in an upward direction, away from the plug. Alternatively or additionally, when the first structure is engaged with the plug, a first side of the first structure, which may be an upper side of the first structure, may abut against or closely encounter a ledge of the equipment and a second side of the first structure, which is opposite to the first side of the first structure and which may be a lower side of the first structure, may abut or closely encounter the first side of the plug. Hence, while in the engaged position, the first structure may be positioned between and abuts or closely encounters the equipment ledge and the plug, which militates against the first structure from being lifted, e.g., in an upward direction, away from the plug. The first structure may comprise a cutout portion for receiving the attachment portion of the plug.

The fastener structure may be receivable in openings formed in the respective first and second structures.

The first structure may include an insertion portion and the second structure may comprise a notch for receiving the insertion portion of the first structure. The notch may provide an alignment aid for the insertion portion so that the first structure is properly aligned with the second structure.

The tamper resistant connector assembly may be used with a plug that provides a connection to an equipment. The plug may comprise a front side for connection to a cable, a back side for connection to the equipment, and a latch assembly that is movable between a locked position in which the plug cannot be released from the equipment, and an unlocked position in which the plug can be released from the equipment.

In accordance with yet another aspect, a tamper resistant connector assembly is provided for selectively allowing and restricting access to a latch assembly of a plug that provides a connection to an equipment. The equipment may be a display device that may include a display screen or graphical user interface (GUI). The equipment, the plug and the connector assembly may be used on a material handling vehicle, such as a forklift truck. The latch assembly is movable between a locked position in which the plug cannot be released from the equipment, and an unlocked position in which the plug can be released from the equipment. The tamper resistant connector assembly comprises a first structure, a second structure, and fastener structure. The first structure is removably engageable with the plug proximate to the latch assembly. When the first structure is engaged with the plug, access to the latch assembly is restricted such that the latch assembly is not able to be moved from the locked position to the unlocked position. When the first structure is not engaged with the plug, access to the latch assembly is permitted such that the latch assembly is able to be moved from the locked position to the unlocked position. The second structure is lockably engageable to the first structure such that the first structure is not able to be disengaged from the plug. The fastener structure is configured to lockably engage the second structure to the first structure.

The second structure may be positionable in first and second positions relative to the first structure, wherein while the second structure is in the first position, the second structure is engaged with the first structure such that the first structure is not able to be disengaged from the plug, and while the second structure is in the second position, the first structure is able to be disengaged from the plug.

The first and second structures may be separate structures.

The first position of the second structure may comprise an attached position where the second structure is attached to the first structure, and the second position of the second structure may comprise a detached position where the second structure is detached from the first structure.

The fastener structure may be a removable structure comprising at least one of a screw, bolt, or pin. The fastener structure may require special tooling to actuate the fastener structure to militate against undesirable tampering with the connector assembly by an unauthorized person.

When the fastener structure is locking the second structure in engagement to the first structure, the fastener structure may be secured to the first structure and create a stop that prevents the second structure from moving from the first position to the second position.

The latch assembly may comprise an arm member and the first structure may comprise blocking structure for restricting access to the arm member. The blocking structure may comprise a pair of blocking elements that extend from a body portion of the first structure toward the plug on respective first and second lateral sides of the arm member when the first structure is engaged with the plug. The blocking structure may block access to the lateral sides of the arm member when the first structure is engaged with the plug. The blocking structure may comprise a first blocking element of the first structure and a second blocking element of the second structure, wherein the first and second blocking elements may enclose an arm member of the latch assembly within a cutout portion of the first structure. The blocking structure may prevent the latch assembly from being moved from a locked position to an unlocked position when the first structure is engaged with the plug.

The second structure may include an extension portion for overlapping at least a part of the first structure while the second structure is in the first position, wherein the extension portion may act as a stop to prevent the first structure from being removed from the plug. The first structure may comprise a groove for receiving the extension portion. The groove of the first structure and the extension portion of the second structure may be correspondingly tapered. The tapered shapes of the groove and the extension portion may prevent the first structure from being pulled away from the plug and/or serve as a positioning aid to ensure that the second structure is installed in the groove in the correct orientation. The extension portion may include a lip for extending over a front face of the first structure to prevent the first structure from being disengaged from the plug.

The first structure may include an insertion portion that is received by an opening defined by an attachment portion of the plug. The attachment portion may comprise an arc-shaped or U-shaped attachment piece. The attachment portion may extend outwardly from a first side of the plug. The opening may be defined between the arc-shaped or U-shaped attachment piece and an arm member of the latch assembly. The placement of the insertion portion in the opening defined by the attachment portion may militate against the first structure from being lifted, e.g., in an upward direction, away from the plug. Alternatively or additionally, when the first structure is engaged with the plug, a first side of the first structure, which may be an upper side of the first structure, may abut against or closely encounter a ledge of the equipment and a second side of the first structure, which is opposite to the first side of the first structure and which may be a lower side of the first structure, may abut or closely encounter the first side of the plug. Hence, while in the engaged position, the first structure may be positioned between and abuts or closely encounters the equipment ledge and the plug, which militates against the first structure from being lifted, e.g., in an upward direction, away from the plug. The first structure may comprise a cutout portion for receiving the attachment portion of the plug.

The fastener structure may be receivable in openings formed in the respective first and second structures.

The first structure may include an insertion portion and the second structure may comprise a notch for receiving the insertion portion of the first structure. The notch may provide an alignment aid for the insertion portion so that the first structure is properly aligned with the second structure.

The tamper resistant connector assembly may be used with a plug that provides a connection to an equipment. The plug may comprise a front side for connection to a cable, a back side for connection to the equipment, and a latch assembly that is movable between a locked position in which the plug cannot be released from the equipment, and an unlocked position in which the plug can be released from the equipment.

### BRIEF DESCRIPTION OF THE DRAWINGS

FIG. 1 is a front view of a tamper resistant connector assembly according to embodiments, wherein the tamper resistant connector assembly is shown as being secured onto a plug connected onto the back side of an exemplary equipment;

FIG. 2 is a perspective view of the tamper resistant connector assembly, plug, and equipment of FIG. 1;

FIG. 3 is an exploded view, taken from the side, of the tamper resistant connector assembly, plug, and equipment of FIG. 1;

FIG. 4 is an exploded perspective view of the tamper resistant connector assembly, plug, and equipment of FIG. 1;

FIG. 5 is an enlarged cross-sectional view taken along line 5-5 in FIG. 4, wherein the tamper resistant connector assembly and select portions of the equipment have been removed for clarity;

FIG. 6 is a perspective view of a back side of the tamper resistant connector assembly and plug of FIG. 1;

FIG. 7 is a front view of an exemplary fastening device of the tamper resistant connector assemblies disclosed herein;

FIG. 8 is a front view of another tamper resistant connector assembly according to embodiments, wherein the tamper resistant connector assembly is shown as being secured onto a plug connected onto the back side of an exemplary equipment;

FIG. 9 is a perspective view of the tamper resistant connector assembly, plug, and equipment of FIG. 8;

FIG. 10 is an exploded view, taken from the side, of the tamper resistant connector assembly, plug, and equipment of FIG. 8;

FIGS. 11 and 12 are exploded perspective views of the tamper resistant connector assembly, plug, and equipment of FIG. 8;

FIG. 13 is an enlarged cross-sectional view taken along line 13-13 in FIG. 9, wherein the tamper resistant connector assembly and select portions of the equipment have been removed for clarity;

FIGS. 14 and 15 are perspective views of a first structure and a second structure, respectively, of another tamper resistant connector assembly according to embodiments;

FIGS. 16 and 17 are perspective views of a first structure and a second structure, respectively, of another tamper resistant connector assembly according to embodiments;

FIGS. 18 and 19 are perspective views of a first structure and a second structure, respectively, of another tamper resistant connector assembly according to embodiments;

FIGS. 20-23 are perspective views of a first structure, a second structure, and the first and second structures together, respectively, of another tamper resistant connector assembly according to embodiments; and

FIG. 24 is a perspective view of a materials handling vehicle according to embodiments.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. It should be understood that multiple combinations of the embodiments described and shown are contemplated and that a particular focus on one embodiment does not preclude its inclusion in a combination of other described embodiments. Numerous alternative embodiments could also be implemented, using either current technology or technology developed after the filing date of this patent, which would still fall within the scope of the claims. All publications and patents cited herein are incorporated herein by reference.

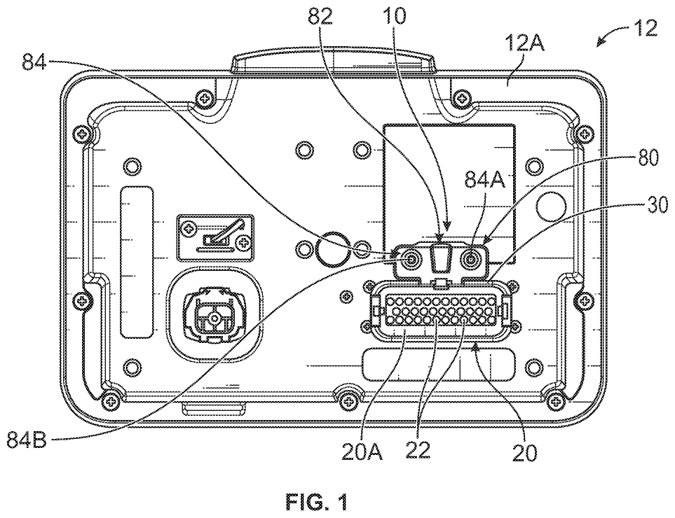

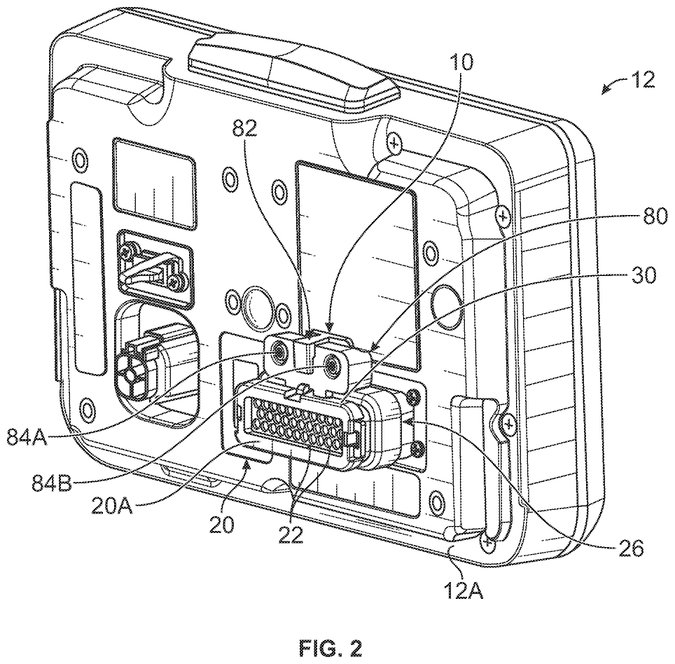

Referring now to the drawings, FIGS. 1-6 illustrate a tamper resistant connector assembly 10 (hereinafter connector assembly 10) according to embodiments. The connector assembly 10 is shown in FIGS. 1 and 2 as being secured onto the back side 12A of exemplary equipment 12. The exemplary equipment 12 shown in FIGS. 1-5 is a display device that may include a display screen or graphical user interface (GUI), although the connector assembly 10 may be used with other types of equipment, examples of which include tablets, laptop computers, bar code readers, printers, scanners, cable connectors between computing equipment, cameras, sensors such as environmental or component specific sensors (lift height, odometry, and the like), status displays or lighting equipment, communication equipment such as UWB, Bluetooth, WiFi, radio, cellular, and the like.

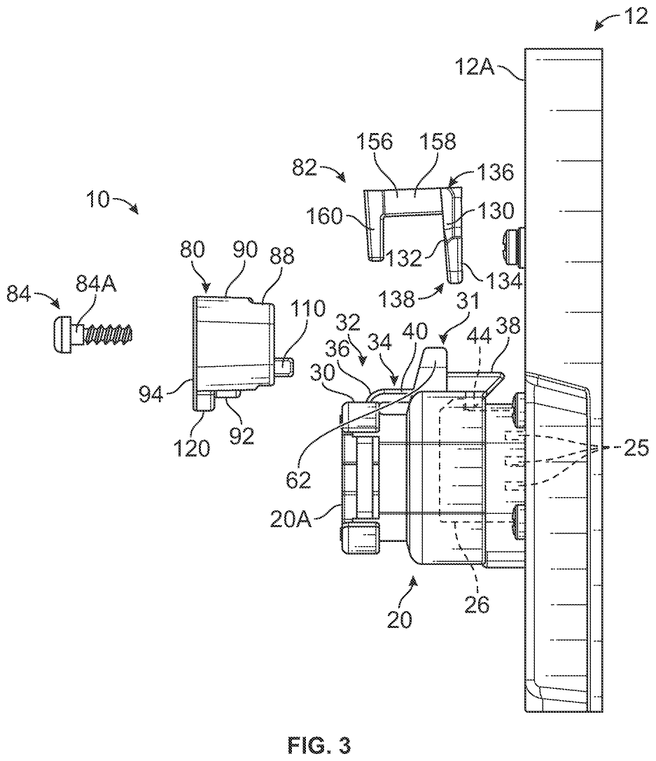

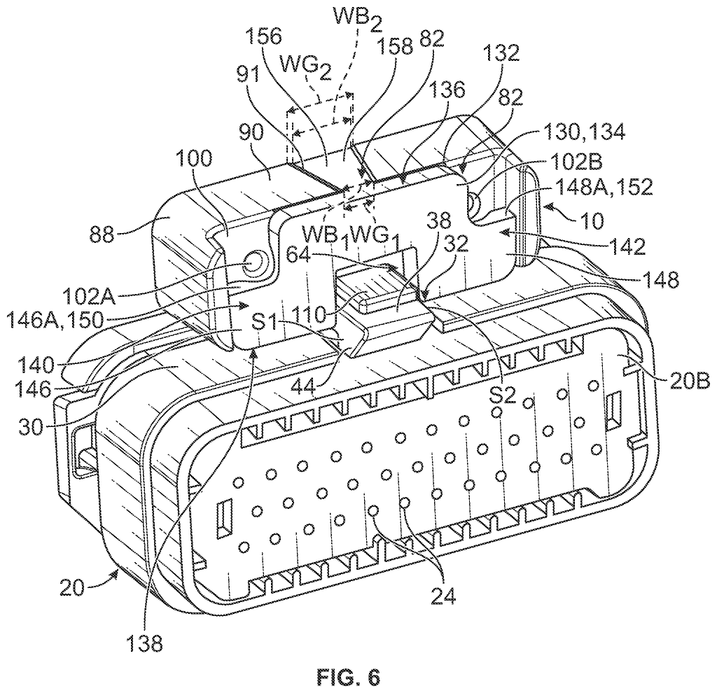

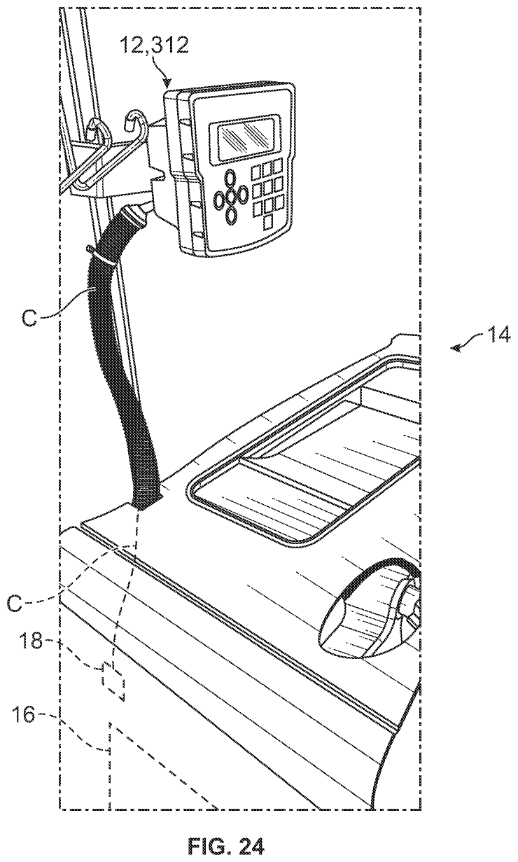

The connector assembly 10 may be used with a plug 20 having a front side 20A, wherein the front side 20A faces away from the equipment 12 when the plug 20 is attached thereto, and a back side 20B (see FIG. 6), wherein the back side 20B faces toward the equipment 12 when the plug 20 is attached thereto. The front side 20A of the plug 20 includes a plurality of first openings 22 for receiving corresponding electrical pins of a cable C (an exemplary cable is shown in FIG. 24). As shown in FIG. 6, the back side 20B of the plug 20 includes a plurality of second openings 24 for receiving corresponding electrical pins 25 (see FIG. 3) extending from a plug port 26 located on the back side 12A of the equipment 12 for electrically coupling the plug 20 to the equipment 12 in a conventional manner.

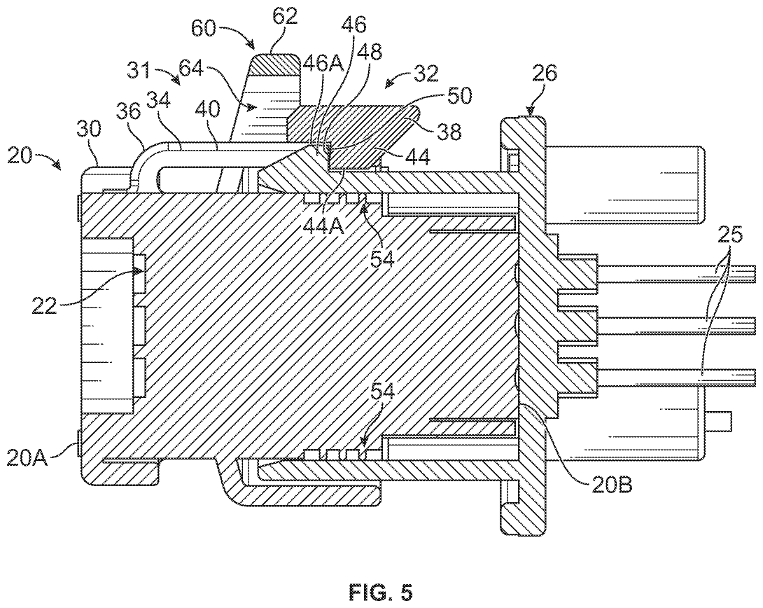

A first side 30 of the plug 20, which is an upper side of the plug 20 as shown in FIGS. 1-6 but could be another side, comprises a latch box 31 (see FIGS. 3-5) that includes a latch assembly 32 for selectively locking and unlocking the plug 20 to the equipment 12 at the plug port 26. As most clearly shown in FIG. 5, the exemplary latch assembly 32 comprises an arm member 34 having a first end 36, a second end 38 spaced apart from the first end 36, and a body portion 40 extending between the first and second ends 36, 38.

With reference to FIG. 5, the first end 36 of the arm member 34 extends outwardly from the first side 30 of the plug 20. The body portion 40 extends from the first end 36 toward the equipment 12 when the plug 20 is inserted in the plug port 26, and is spaced from the first side 30 of the plug 20. The second end 38 of the arm member 34 is free-floating, as it is not directly affixed to the first side 30 of the plug 20 and hovers over the first side 30 of the plug 20. Since the second end 38 is free-floating, the body portion 40 and the second end 38 of the arm member 34 can be moved relative to the first side 30 of the plug 20, with the first end 36 of the arm member 34 providing a pivot point, as will be discussed in more detail below.

The second end 38 of the arm member 34 includes at least one locking structure 44 that selectively engages at least one corresponding locking element 46 of the plug port 26 to selectively secure the plug 20 to the plug port 26. As shown in FIG. 5, the locking structure 44 may be a protuberance that extends in a direction toward the first side 30 of the plug 20, and includes a generally flat first surface 48 facing toward the first end 36 of the arm member 34. The locking element 46 may be a protuberance that includes a generally flat second surface 50 facing toward the back side 12A of the equipment 12. While the arm member 34 is in a locking position, otherwise referenced herein as a home position, the first surface 48 of the locking structure 44 aligns with the second surface 50 of the locking element 46 to lock the plug 20 to the equipment 12 at the plug port 26, i.e., while the arm member 34 is in the locking position and the first surface 48 of the locking structure 44 aligns with the second surface 50 of the locking element 46, the plug 20 is prevented from being pulled out of the plug port 26.

As noted above, the body portion 40 and the second end 38 of the arm member 34 can be moved relative to the first side 30 of the plug 20, with the first end 36 of the arm member 34 providing a pivot point. As the body portion 40 and second end 38 of the arm member 34 are moved away from the first side 30 of the plug 20, the latch assembly 32 is moved to an unlocked position, otherwise referenced herein as a released position, wherein the first surface 48 of the locking structure 44 is no longer aligned with the second surface 50 of the locking element 46, wherein a tip 44A (see FIG. 5) of the locking structure 44 moves past a tip 46A (see FIG. 5) of the locking element 46 such that the first surface 48 of the locking structure 44 is no longer aligned with the second surface 50 of the locking element 46, thus allowing the plug 20 to be pulled out of the plug port 26. When the latch assembly 32 is in the locking position, the plug 20 is locked to the plug port 26 and cannot be released from the equipment 12, and when the latch assembly 32 is in the unlocked position, the plug 20 is unlocked from the plug port 26 and can be released from the equipment 12, e.g., by an operator pulling the plug 20 away from the back side 12A of the equipment 12. A gasket 54 may be provided on the plug 20 to seal off the inside of the plug port 26 after the plug 20 is connected to the plug port 26, see FIG. 5.

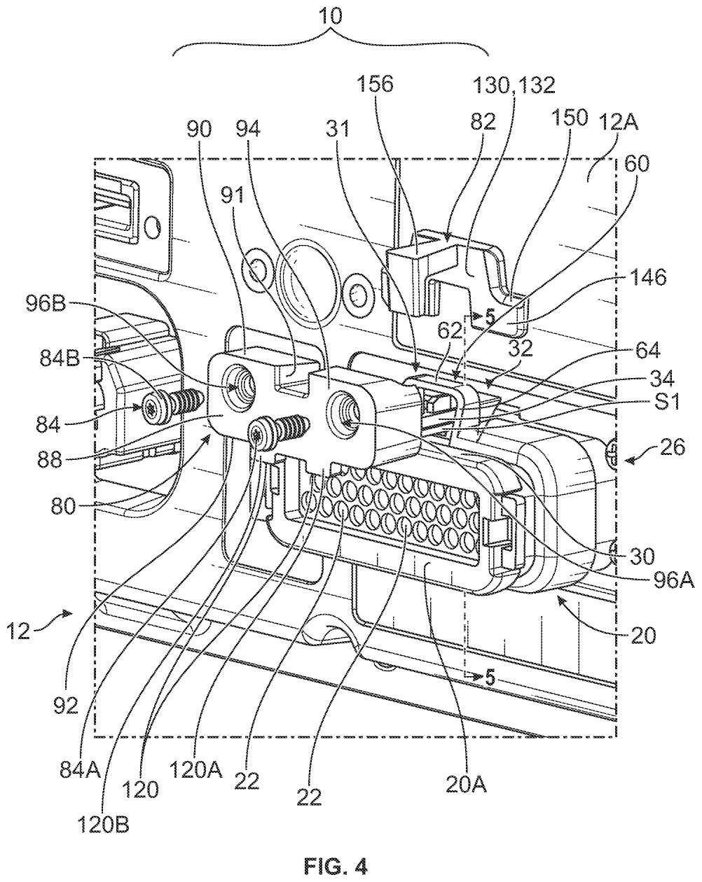

With reference to FIGS. 3-5, the latch box 31 of the plug 20 further comprises an attachment portion 60 to which the connector assembly 10 may attach, as will be discussed below. The attachment portion 60 according to this embodiment comprises an arc-shaped or U-shaped attachment piece 62 that extends outwardly from the first side 30 of the plug 20. An opening 64 is defined within the attachment piece 62, i.e., between the attachment piece 62 and the arm member 34, see FIGS. 4 and 5.

It is noted that the plug 20 and its latch assembly 32 according to this embodiment is exemplary and could take other forms as desired. For example, other types of plugs and/or other types of latch assemblies could be used, where an operator is able to manually actuate a component of the latch assembly to unlock it and therefor permit a removal of the associated plug from a plug port in which the plug is inserted.

The connector assembly 10 according to this embodiment will now be described. As most clearly shown in FIGS. 3 and 4, the connector assembly 10 comprises a first structure 80, a second structure 82, and fastener structure 84, which comprises first and second screws 84A, 84B in the embodiment shown. It is noted that other suitable types of fastener structure could be used, including removable fastener structures such as, for example, bolts, pins, tamper resistant fasteners such as spanner screws, Torx® (Torx is a registered trademark of ACUMENT INTELLECTUAL PROPERTIES, LLC) with pin screws, one-way security screws and like bolts, tri-groove security nuts, and the like, and also non-removable fastener structure, such as rivets, adhesives, break-away sheer nuts, etc. The first and second structures 80, 82 are separate structures that are removably and lockably engageable with each other, as will be described below.

The first structure 80 includes a body portion 88 comprising a first side 90, which comprises an upper side including a groove 91 (see FIG. 4) in the embodiment shown, and a second side 92, which comprises a lower side in the embodiment shown and which is opposed from the first side 90. The body portion 88 also comprises a front face 94 that includes a pair of inlet openings 96A, 96B (see FIG. 4) for respectively receiving the first and second screws 84A, 84B, and a rear face 100, see FIG. 6. The rear face 100 includes a pair of outlet openings 102A, 102B that communicate with the respective inlet openings 96A, 96B so as to allow the first and second screws 84A, 84B to extend out of the rear face 100 of the first structure 80.

The first structure 80 further comprises an insertion portion 110 (see FIGS. 3 and 6) that extends from the body portion 88 and is received by the opening 64 defined by the attachment portion 60 of the plug 20 when the first structure 80 is in an engaged position with the plug 20. While in the engaged position, the first structure 80 is engaged with the attachment portion 60 of the plug 20, and the placement of the insertion portion 110 in the opening 64 defined by the attachment portion 60 of the plug 20 militates against the first structure 80 from being lifted (in an upward direction as shown in the figures) away from the plug 20 in the embodiment shown. The engaged position of the first structure 80 is shown most clearly in FIGS. 1, 2, and 6, and FIGS. 3 and 4 show the first structure 80 in a non-engaged position.

As most clearly shown in FIGS. 3 and 4, the first structure 80 according to this embodiment also includes blocking structure 120 for restricting access to the arm member 34 of the latch assembly 32 while the first structure 80 is in the engaged position. The exemplary blocking structure 120 according to this embodiment comprises a pair of blocking elements 120A, 120B that extend from the body portion 88 of the first structure 80 toward the plug 20 on respective first and second lateral sides S1, S2 of the arm member 34 (see FIG. 6) when the first structure 80 is engaged with the plug 20. By blocking access to the lateral sides S1, S2 of the arm member 34, the arm member 34 is not able to be moved, thus preventing the latch assembly 32 from being moved from the locked position to the unlocked position when the first structure 80 is engaged with the plug 20, i.e., while in the engaged position, the first structure 80 restricts access to the arm member 34, thus preventing the latch assembly 32 from being moved from the locked position to the unlocked position. While the first structure 80 is not engaged with the plug 20, access to the latch assembly 32 is permitted such that the latch assembly 32 is able to be moved from the locked position to the unlocked position.

With reference to FIGS. 3, 4, and 6, the second structure 82 includes a body portion 130 comprising a front face 132, a rear face 134, a first section 136 comprising an upper section in the embodiment shown, a second section 138 comprising a lower section in the embodiment shown, and left and right side sections 140, 142. First and second flanges 146, 148 extend from the respective left and right side sections 140, 142 at the second section 138 of the body portion 130, see FIG. 6. The flanges 146, 148 define first and second notches 150, 152 adjacent to the respective left and right side sections 140, 142 at the first section 136 of the body portion 130. Upper surfaces 146A, 148A of the first and second flanges 146, 148 define respective abutment surfaces for the first and second screws 84A, 84B, which first and second screws 84A, 84B are received in the notches 150, 152 when second structure 82 is in a first position and the connector assembly 10 is in a fully assembled position on the plug 20, as will be described in detail below. The first position of the second structure 82 comprises an attached position wherein the second structure 82 is attached to the first structure 80 with the attachment portion 60 of the plug 20 located between the first and second structures 80, 82, as shown most clearly in FIGS. 1, 2, and 6. A second position of the second structure 82 comprises a detached position wherein the second structure 82 is detached from the first structure 80, as shown in FIGS. 3 and 4.

The second structure 82 according to this embedment further comprises an extension portion 156 that, while the second structure 82 is in the first position, acts as a stop to prevent the first structure 80 from being removed from the plug 20. The extension portion 156 includes a base 158 that extends transversely from the second structure front face 132 at the first section 136 and overlaps the first side 90 of the first structure 80 while the second structure 82 is in the first position. The base 158 may be received in the groove 91 of the first structure 80, as shown most clearly in FIG. 6. The extension portion 156 further comprises a lip 160 that extends transversely from the base 158 and may be generally parallel to the second structure front face 132. The lip 160 extends over the front face 94 of the first structure 80 to prevent the first structure 80 from being disengaged from the plug 20 when the second structure 82 is in the first position, i.e., the lip 160 acts as a stop to prevent the first structure 80 from being pulled away from the plug 20 in a direction away from the back side 12A of the equipment 12.

The groove 91 formed in the first structure 80 and the base 158 of the second structure extension portion 156 may be correspondingly tapered as most clearly shown in FIG. 6. For example, the groove 91 and base 158 may have respective first widths WG₁, WB₁ at portions proximate to the second structure front face 132 that are less than second widths WG₂, WB₂ thereof at portions distal from the second structure front face 132. If the lip 160 of the extension portion 156 is broken off, the tapered shapes of the groove 91 and base 158 will prevent the first structure 80 from being pulled away from the plug 20 in a direction away from the back side 12A of the equipment 12. The tapered shapes of the groove 91 and base 158 may also serve as a positioning aid to ensure that the second structure 82 is installed in the groove 91 in the correct orientation.

According to embodiments, the connector assembly 10 can be used to prevent access to the latch assembly 32. Specifically, when the connector assembly 10 is installed on the plug 20 (with the first structure 80 in the engaged position, i.e., engaged with the plug 20, the second structure 82 in the first position, i.e., attached to the first structure 80, and the fastener structure 84 installed within the inlet openings 96A, 96B and received in the notches 150, 152), the arm member 34 is not able to be moved from the locked position to the unlocked position, such that when the connector assembly 10 is installed, the plug 20 cannot be released from the plug port 26. The existence of the attachment portion 60 of the plug 20 between the first and second structures 80, 82 prevents the connector assembly 10 from being removed from the plug 20, i.e., the connector assembly 10 can only be removed from the plug 20 when the second structure 82 is removed from the first structure 80. In turn, the plug 20 can only be released from the plug port 26 when the connector assembly 10 is removed from the plug 20. When the fastener structure 84 is locking the second structure 82 in engagement to the first structure 80, the fastener structure 84 is secured to the first structure 80 and creates a stop that prevents the second structure 82 from moving from the first position to the second position.

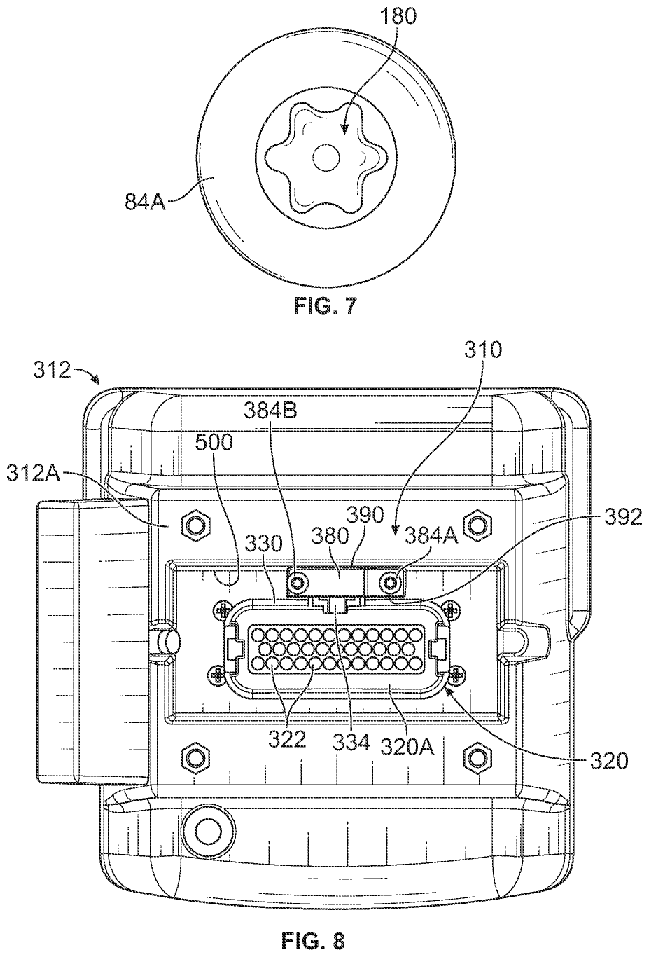

With reference to FIG. 7, the first screw 84A (the second screw 84B may be identical to the first screw 84A) according to embodiments may have a bore 180 that requires special tooling, such as a Torx® driver, to insert and extract the screw 84A from the first structure inlet openings 96A. By requiring special tooling to insert/extract the screws 84A, 84B, undesirable tampering with the connector assembly 10 by an unauthorized person, such as a vehicle operator, is militated against.

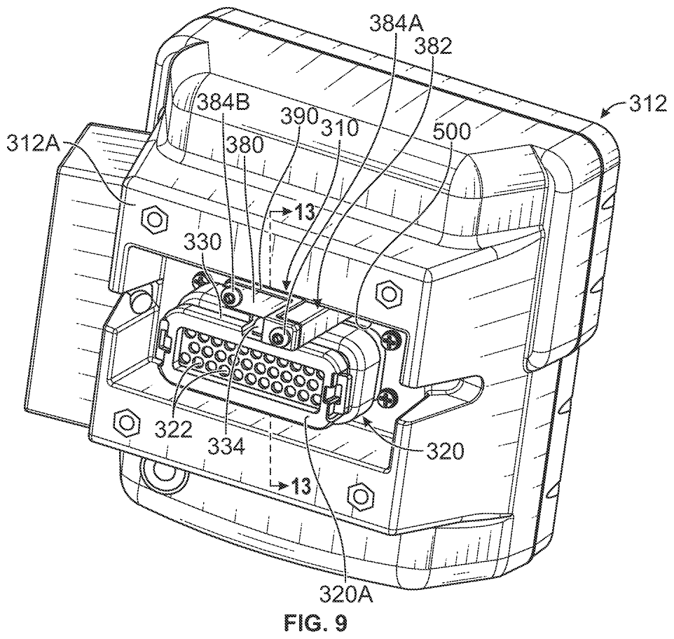

With reference now to FIGS. 8-12, a tamper resistant connector assembly 310 (hereinafter connector assembly 310) is illustrated according to embodiments. The connector assembly 310 is shown in FIGS. 8 and 9 as being secured onto the back side 312A of exemplary equipment 312. The exemplary equipment 312 shown in FIGS. 8-12 is a display device that may include a display screen or graphical user interface (GUI), although the connector assembly 310 may be used with other types of equipment, examples of which include tablets, laptop computers, bar code readers, printers, scanners, cable connectors between computing equipment, cameras, sensors such as environmental or component specific sensors (lift height, odometry, and the like), status display or lighting equipment, communication equipment such as UWB, Bluetooth, WiFi, radio, cellular, and the like.

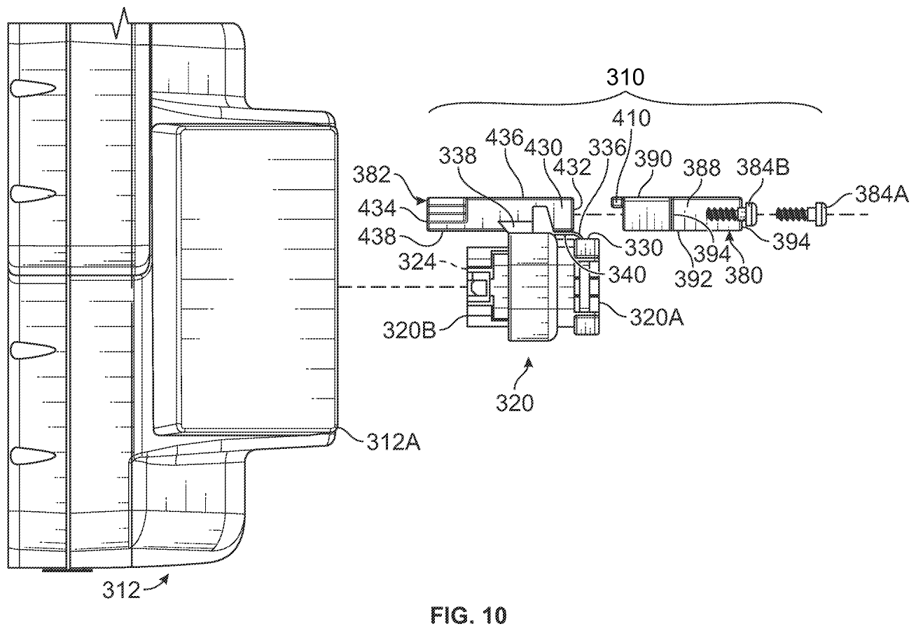

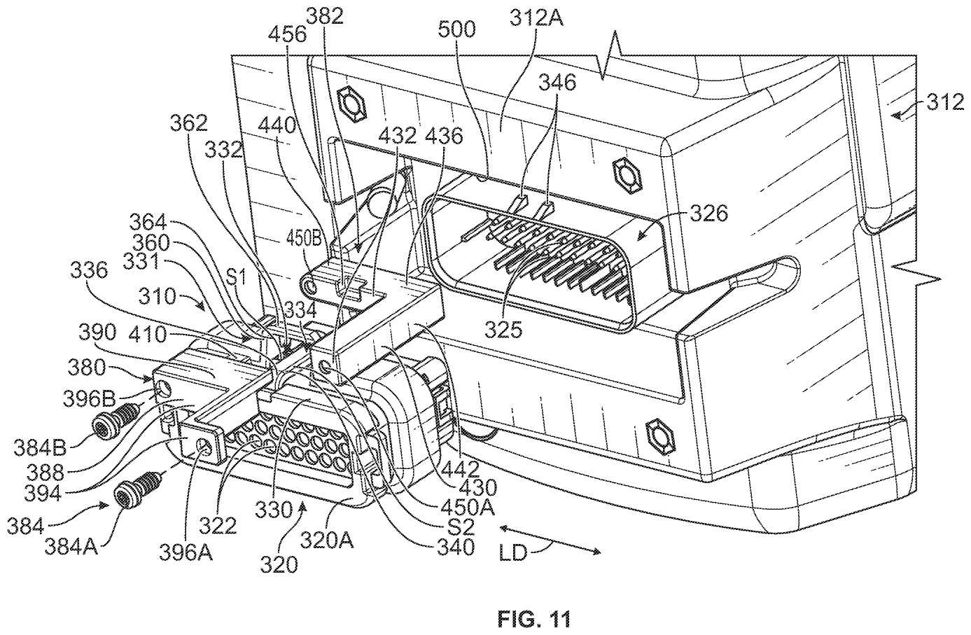

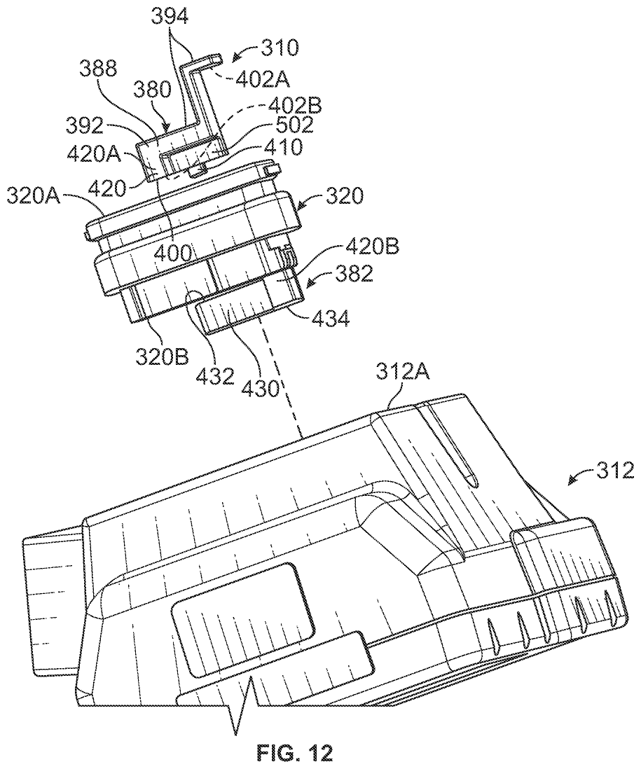

The connector assembly 310 may be used with a plug 320 having a front side 320A, wherein the front side 320A faces away from the equipment 312 when the plug 320 is attached thereto, and a back side 320B (see FIGS. 10 and 12), wherein the back side 320B faces toward the equipment 312 when the plug 320 is attached thereto. The front side 320A of the plug 320 includes a plurality of first openings 322 for receiving corresponding electrical pins of a cable C (an exemplary cable is shown in FIG. 24). The back side 320B of the plug 320 includes a plurality of second openings 324 for receiving corresponding electrical pins 325 extending from a plug port 326 (see FIG. 11) located on the back side 312A of the equipment 312 for electrically coupling the plug 320 to the equipment 312 in a conventional manner.

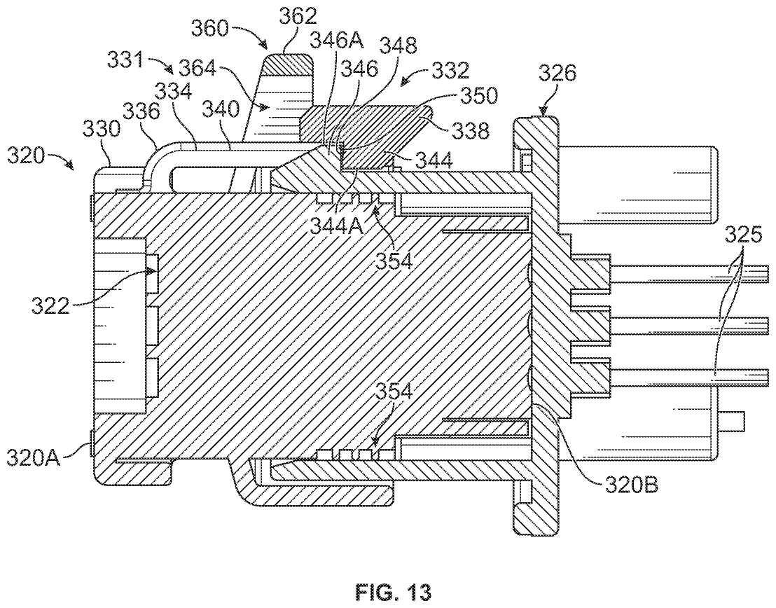

A first side 330 of the plug 320, which is an upper side of the plug 320 as shown in FIGS. 8-11 but could be another side, comprises a latch box 331 (see FIG. 11) that includes a latch assembly 332 for selectively locking and unlocking the plug 320 to the equipment 312 at the plug port 326. As most clearly shown in FIG. 13, the exemplary latch assembly 332 comprises an arm member 334 having a first end 336, a second end 338 spaced apart from the first end 336, and a body portion 340 extending between the first and second ends 336, 338.

With reference to FIG. 13, the first end 336 of the arm member 334 extends outwardly from the first side 330 of the plug 320. The body portion 340 extends from the first end 336 toward the equipment 312 when the plug 320 is inserted in the plug port 326, and is spaced from the first side 330 of the plug 320. The second end 338 of the arm member 334 is free-floating, as it is not directly affixed to the first side 330 of the plug 320 and hovers over the first side 330 of the plug 320. Since the second end 338 is free-floating, the body portion 340 and the second end 338 of the arm member 334 can be moved relative to the first side 330 of the plug 320, with the first end 336 of the arm member 334 providing a pivot point, as will be discussed in more detail below.

The second end 338 of the arm member 334 includes at least one locking structure 344 that selectively engages at least one corresponding locking element 346 of the plug port 326 to selectively secure the plug 320 to the plug port 326. As shown in FIG. 13, the locking structure 344 may be a protuberance that extends in a direction toward the first side 330 of the plug 320, and includes a generally flat first surface 348 facing toward the first end 336 of the arm member 334. The locking element 346 may be a protuberance that includes a generally flat second surface 350 facing toward the back side 312A of the equipment 312. While the arm member 334 is in a locking position, otherwise referenced herein as a home position, the first surface 348 of the locking structure 344 aligns with the second surface 350 of the locking element 346 to lock the plug 320 to the equipment 312 at the plug port 326, i.e., while the arm member 334 is in the locking position and the first surface 348 of the locking structure 344 aligns with the second surface 350 of the locking element 346, the plug 320 is prevented from being pulled out of the plug port 326.

As noted above, the body portion 340 and the second end 338 of the arm member 334 can be moved relative to the first side 330 of the plug 320, with the first end 336 of the arm member 334 providing a pivot point. As the body portion 340 and second end 338 of the arm member 334 are moved away from the first side 330 of the plug 320, the latch assembly 332 is moved to an unlocked position, otherwise referenced herein as a released position, wherein the first surface 348 of the locking structure 344 is no longer aligned with the second surface 350 of the locking element 346, wherein a tip 344A (see FIG. 13) of the locking structure 344 moves past a tip 346A (see FIG. 13) of the locking element 346 such that the first surface 348 of the locking structure 344 is no longer aligned with the second surface 350 of the locking element 346, thus allowing the plug 320 to be pulled out of the plug port 326. When the latch assembly 332 is in the locking position, the plug 320 is locked to the plug port 326 and cannot be released from the equipment 312, and when the latch assembly 332 is in the unlocked position, the plug 320 is unlocked from the plug port 326 and can be released from the equipment 312, e.g., by an operator pulling the plug 320 away from the back side 312A of the equipment 312. A gasket 354 may be provided on the plug 320 to seal off the inside of the plug port 326 after the plug 320 is connected to the plug port 326, see FIG. 13.

With reference to FIGS. 11 and 13, the latch box 331 of the plug 320 further comprises an attachment portion 360 to which the connector assembly 310 may attach, as will be discussed below. The attachment portion 360 according to this embodiment comprises an arc-shaped or U-shaped attachment piece 362 that extends outwardly from the first side 330 of the plug 320. An opening 364 is defined within the attachment piece 362, i.e., between the attachment piece 362 and the arm member 334.

It is noted that the plug 320 and its latch assembly 332 according to this embodiment is exemplary and could take other forms as desired. For example, other types of plugs and/or other types of latch assemblies could be used, where an operator is able to manually actuate a component of the latch assembly to unlock it and therefor permit a removal of the associated plug from a plug port in which the plug is inserted.

The connector assembly 310 according to this embodiment will now be described. As most clearly shown in FIGS. 10 and 11, the connector assembly 310 comprises a first structure 380, a second structure 382, and fastener structure 384, which comprises first and second screws 384A, 384B in the embodiment shown. It is noted that other suitable types of fastener structure could be used, including removable fastener structures such as, for example, bolts, pins, tamper resistant fasteners such as spanner screws, Torx® with pin screws, one-way security screws and like bolts, tri-groove security nuts, and the like, and also non-removable fastener structure, such as rivets, adhesives, break-away sheer nuts, etc. The first and second structures 380, 382 are separate structures that are removably and lockably engageable with each other, as will be described below.

The first structure 380 includes a body portion 388 comprising a first side 390, which comprises an upper side in the embodiment shown, and a second side 392 (see FIGS. 10 and 12), which comprises a lower side in the embodiment shown and which is opposed from the first side 390. The body portion 388 also comprises a front face 394 that includes a pair of inlet openings 396A, 396B (see FIG. 11) for respectively receiving the first and second screws 384A, 384B, and a rear face 400, see FIG. 12. The rear face 400 includes a pair of outlet openings 402A, 402B that communicate with the respective inlet openings 396A, 396B so as to allow the first and second screws 384A, 384B to extend out of the rear face 400 of the first structure 380.

When the first structure 380 is in an engaged position with the plug 320, the first side 390 of the first structure 380 abuts against or closely encounters a ledge 500 of the equipment 312 that faces the plug port 326, and the second side 392 of the first structure 380 abuts or closely encounters the first side 330 of the plug 320, see FIGS. 8 and 9. Hence, while in the engaged position, the first structure 380 is positioned between and abuts or closely encounters the equipment ledge 500 and the plug 320, which militates against the first structure 380 from being lifted (in an upward direction as shown in the figures) away from the plug 320. The engaged position of the first structure 380 is shown most clearly in FIGS. 8 and 9, and FIGS. 10-12 show the first structure 380 in a non-engaged position.

As shown most clearly in FIGS. 11 and 12, the first structure 380 according to this embodiment includes an insertion portion 410 that extends from the rear face 400 at the first side 390. A cutout portion 502 is defined in the body portion 388 of the first structure 380 rear face 400. The attachment piece 362 of the latch box 331 is received in the cutout portion 502 when the first structure 380 is in the engaged position, as will be described in more detail below.

With reference to FIGS. 10-12, the second structure 382 includes a body portion 430 comprising a front face 432, a rear face 434, a first section 436 comprising an upper section in the embodiment shown, and a second section 438 comprising a lower section in the embodiment shown, and left and right side sections 440, 442. First and second openings 450A, 450B (see FIG. 11) are located in the front face 432 and the respective left and right side sections 440, 442 of the body portion 430. The openings 450A, 450B receive the first and second screws 384A, 384B when second structure 382 is in a first position and the connector assembly 310 is in a fully assembled position on the plug 320, as will be described in detail below. The first position of the second structure 382 comprises an attached position wherein the second structure 382 is attached to the first structure 380 with the attachment portion 360 of the plug 320 located in the cutout portion 502 of the first structure 380 and between the first and second structures 380, 382, as shown most clearly in FIGS. 8, 9, and 13. A second position of the second structure 382 comprises a detached position wherein the second structure 382 is detached from the first structure 380, as shown in FIGS. 10-12.

The second structure 382 according to this embodiment further comprises a notch 456 that, while the second structure 382 is in the first position, receives the insertion portion 410 of the first structure 380. The notch 456 may provide an alignment aid for the insertion portion 410 so that the first structure 380 is properly aligned with the second structure 382, i.e., so that the first and second screws 384A, 384B can extend through both the inlet openings 396A, 396B and the outlet openings 402A, 402B of the first structure 380 and through the openings 450A, 450B in the second structure 382. The insertion of the insertion portion 410 into the notch 456 may also act as a stop to prevent the first structure 380 from moving in a lateral direct LD (see FIG. 11) with respect to the second structure 382.

The connector assembly 310 according to this embodiment also includes blocking structure 420 (see FIG. 12) for restricting access to the arm member 334 of the latch assembly 332 while the first structure 380 is in the engaged position and the second structure 382 is in the first position. The exemplary blocking structure 420 according to this embodiment comprises a first blocking element 420A of the first structure 380 adjacent to the cutout portion 502 on a first lateral side S1 of the arm member 334 (see FIG. 11), and a second blocking element 420B of the second structure 380 adjacent to the cutout portion 502 on a second lateral side S2 of the arm member 334 (see FIG. 11). The first and second blocking elements 420A, 420B thus enclose the arm member 334 of the latch assembly 332 within the cutout portion 502 of the first structure 380.

By blocking access to the arm member 334, the arm member 334 is not able to be moved, thus preventing the latch assembly 332 from being moved from the locked position to the unlocked position when the first structure 380 is engaged with the plug 320 and the second structure 382 is in the first position, i.e., while the first structure 380 is in the engaged position and the second structure 382 is in the first position, the first and second structures 380, 382 restrict access to the arm member 334, thus preventing the latch assembly 332 from being moved from the locked position to the unlocked position. While the first structure 380 is not engaged with the plug 320 and the second structure 382 is in the second position, access to the latch assembly 332 is permitted such that the latch assembly 332 is able to be moved from the locked position to the unlocked position. Thus, when the connector assembly 310 is installed on the plug 320 (with the first structure 380 in the engaged position, i.e., engaged with the plug 320, the second structure 382 in the first position, i.e., attached to the first structure 380, and the fastener structure 384 installed within the inlet openings 396A, 396B and the outlet openings 402A, 402B of the first structure 380 and the openings 450A, 450B in the second structure 382), the plug 320 cannot be released from the plug port 326. The existence of the attachment portion 360 of the plug 320 between the first and second structures 380, 382 prevents the connector assembly 310 from being removed from the plug 320, i.e., the connector assembly 310 can only be removed from the plug 320 when the second structure 382 is removed from the first structure 380. In turn, the plug 320 can only be released from the plug port 326 when the connector assembly 310 is removed from the plug 320. When the fastener structure 384 is locking the second structure 382 in engagement to the first structure 380, the fastener structure 384 is secured to the first structure 380 and creates a stop that prevents the second structure 382 from moving from the first position to the second position.

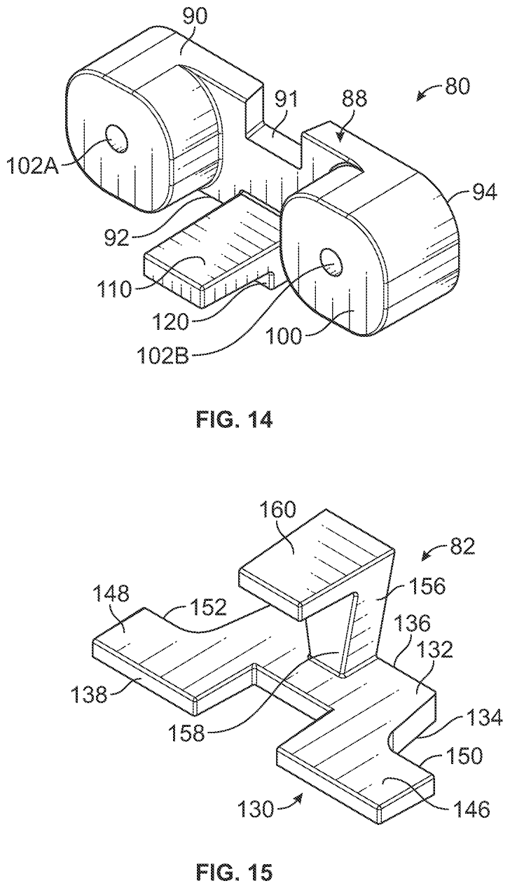

FIGS. 14 and 15 depict respective first and second structures 80, 82 of a tamper resistant connector assembly according to embodiments. The first and second structures 80, 82 according to this embodiment, while having moderately different appearances, are substantially similar to the first and second structures 80, 82 of the connector assembly 10 described herein with reference to FIGS. 1-6, and only the significant differences between these respective structures will be specifically discussed herein.

With reference to FIG. 14, the first structure 80 according to this embodiment includes a single blocking structure 120 for restricting access to an arm member of a latch assembly while the first structure 80 is in an engaged position with the plug (the plug according to this embodiment may be the same as the plug 20 described above for FIGS. 1-6). The single blocking structure 120 according to this embodiment is positioned in front of the arm member 34 to restrict access thereto. While the appearance of other portions of the first structure 80 according to this embodiment may be slightly different than those of the first structure 80 according to the embodiment of FIGS. 1-6, the functionality is the same and thus will not be specifically repeated herein for brevity.

Turning now to FIG. 15, the configuration of the second structure 82 according to this embodiment is substantially similar to the second structure 82 according to the embodiment of FIGS. 1-6 and thus will not be specifically repeated herein for brevity.

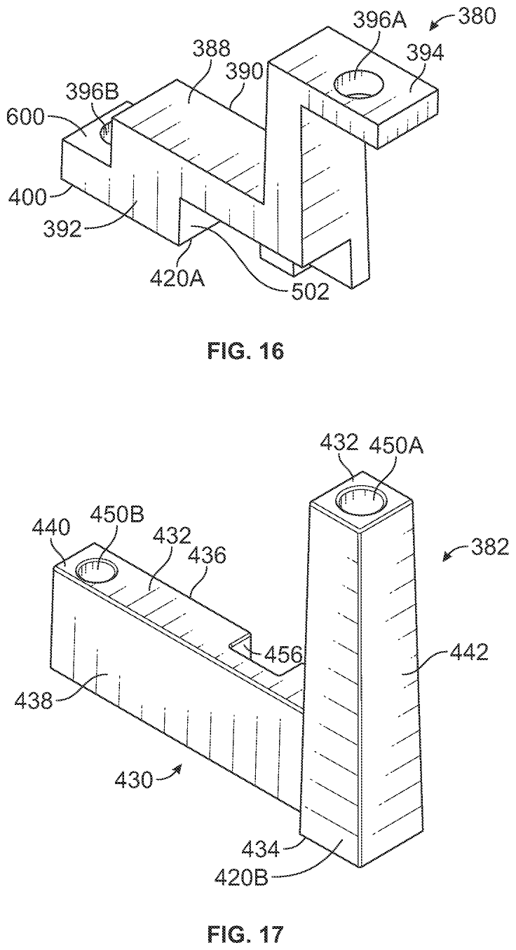

FIGS. 16 and 17 depict respective first and second structures 380, 382 of a tamper resistant connector assembly according to embodiments. The first and second structures 380, 382 according to this embodiment are substantially similar to the first and second structures 380, 382 of the connector assembly 310 described herein with reference to FIGS. 8-13, and only the significant differences between these respective structures will be specifically discussed herein.

With reference to FIG. 16, the second inlet opening 396B and the corresponding second outlet opening 402B of the first structure 380 according to this embodiment are located in a step portion 600 that extends from a lateral side of the body portion 388 of the first structure 380. Other than the location of the second inlet and outlet openings 396B, 402B in the step portion 600, the configuration of the first structure 380 according to this embodiment is substantially similar to the first structure 380 according to the embodiment of FIGS. 8-13 and thus will not be specifically repeated herein for brevity.

Turning now to FIG. 17, the second structure 382 according to this embodiment is slightly wider than the second structure 382 according to the embodiment of FIGS. 8-13. The larger width is provided to accommodate for the location of the second inlet and outlet openings 396B, 402B in the step portion 600 of the first structure 380 as discussed above. Other than the change in width, the configuration of the second structure 382 according to this embodiment is substantially similar to the second structure 382 according to the embodiment of FIGS. 8-13 and thus will not be specifically repeated herein for brevity.

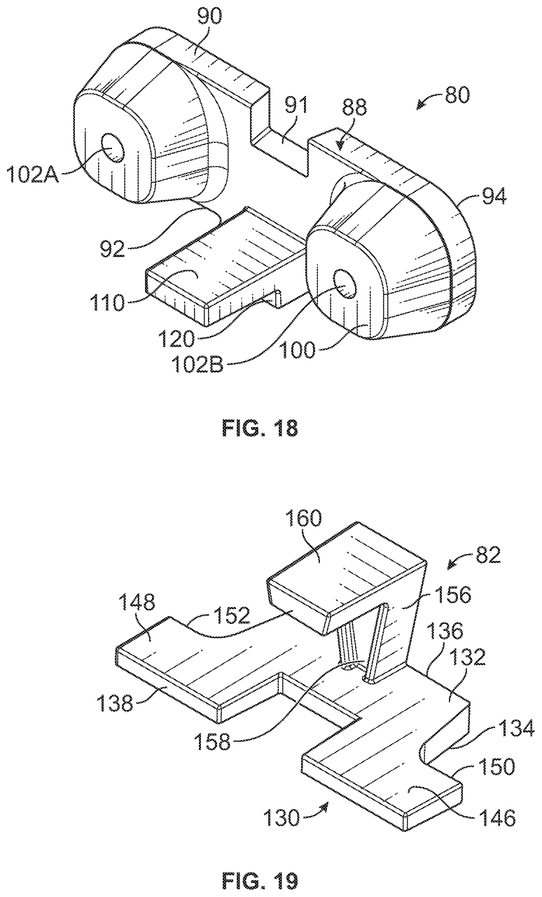

FIGS. 18 and 19 depict respective first and second structures 80, 82 of a tamper resistant connector assembly according to embodiments. The first and second structures 80, 82 according to this embodiment, while having slightly different appearances, are substantially similar to the first and second structures 80, 82 of the connector assembly 10 described herein with reference to FIGS. 14 and 15, and only the significant differences between these respective structures will be specifically discussed herein.

With reference to FIG. 18, the primary distinction between the first structure 80 according to this embodiment and the first structure 80 according to FIG. 14 is that components that include the outlet openings 102A, 102B have tapered profiles as they extend away from the second side 92 of the body portion 88. While the appearance of other portions of the first structure 80 according to this embodiment may be slightly different than those of the first structure 80 according to the embodiment of FIGS. 1-6 and/or the embodiment of FIG. 14, the functionality is the same and thus will not be specifically repeated herein for brevity.

Turning now to FIG. 19, the configuration of the second structure 82 according to this embodiment is substantially similar to the second structure 82 according to the embodiment of FIGS. 1-6 and the embodiment of FIG. 15 and thus will not be specifically repeated herein for brevity.

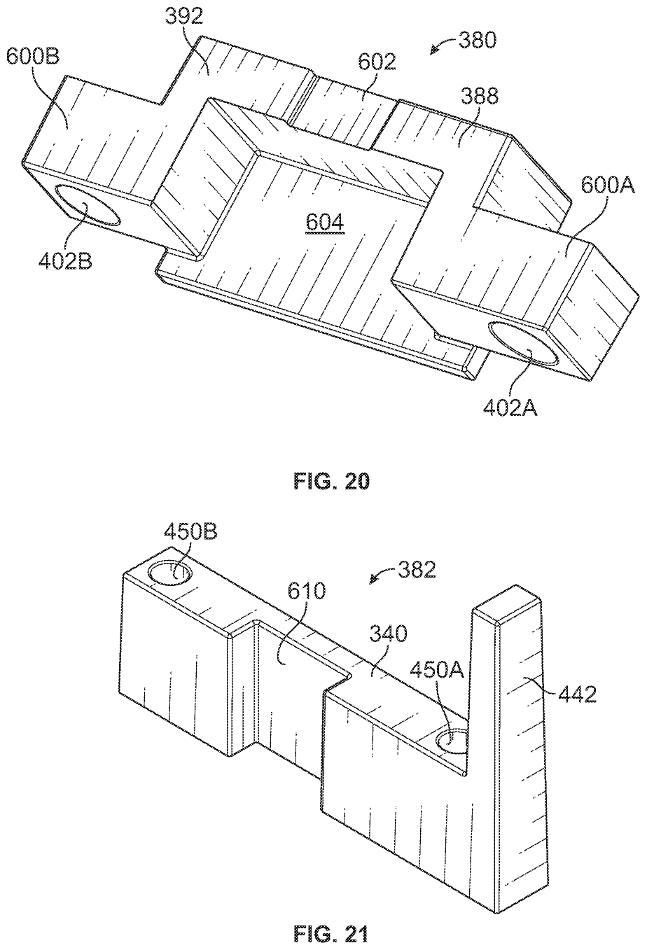

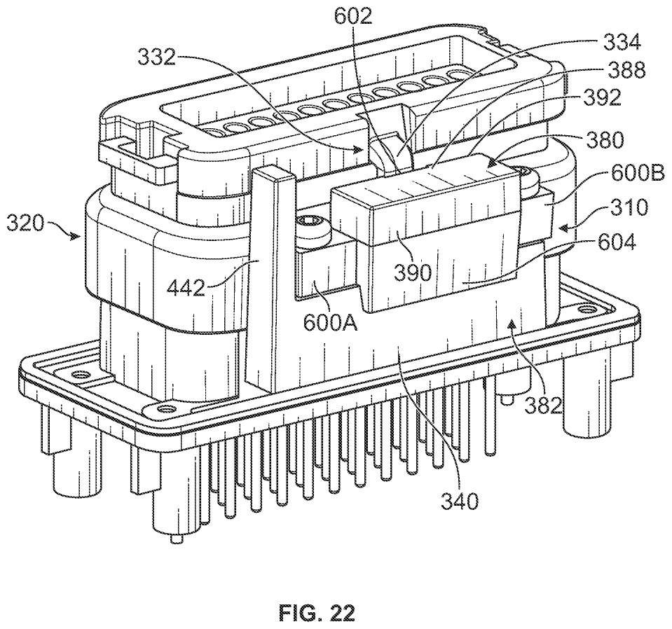

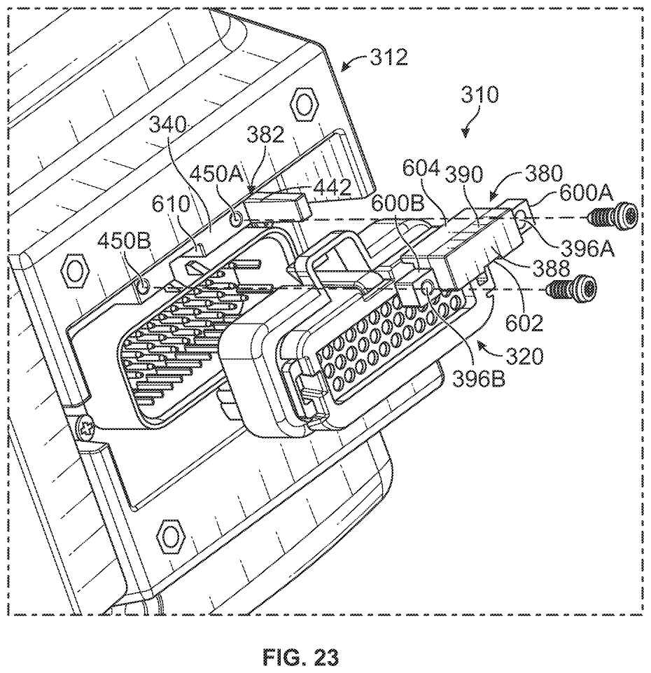

With reference now to FIGS. 20-23, FIGS. 20 and 21 depict respective first and second structures 380, 382 of a tamper resistant connector 310 assembly according to embodiments, FIG. 22 shows the tamper resistant connector 310 engaged with a plug 320, and FIG. 23 is a partially exploded view showing the tamper resistant connector 310, the plug 320, and exemplary equipment 312. The first and second structures 380, 382 according to this embodiment are similar to the first and second structures 380, 382 of the connector assembly 310 described herein with reference to FIGS. 16 and 17, and only the significant differences between these respective structures will be specifically discussed herein.

With reference to FIG. 20, a body portion 388 of the first structure 380 according to this embodiment takes a different shape but includes the same function as that of the first structure 380 according to FIG. 16. The first and second inlet openings 396A, 396B (see FIG. 23) and the corresponding first and second outlet openings 402A, 402B of the first structure 380 according to this embodiment are located in step portions 600A, 600B that extend from respective lateral sides of the body portion 388 of the first structure 380. A groove 602 is formed a second side 392 of the body portion 388, wherein the groove 602 is located adjacent to the arm member 334 of the latch assembly 332 while the first structure 380 is in the engaged position with the plug 320, see FIG. 22. A tongue member 604 of the first structure 380 extends from a first side 390 of the body portion 388 opposite from the groove 602. The tongue member 604 may serve as an alignment aid for properly positioning the first structure 380 into engagement with the second structure 382 and the plug 320, and may further provide a cover for components of the latch assembly 332. While the appearance of the first structure 380 according to this embodiment is significantly different than that of the first structure 380 according to the embodiment of FIG. 16, the function thereof is essentially the same and thus will not be specifically repeated herein for brevity.

Turning now to FIG. 21, the first opening 450A of the second structure 382 according to this embodiment is located in the body portion 340 instead of in the right side section 442 as with the embodiment described above with reference to FIG. 17. The second structure 382 according to this embodiment also includes a groove 610 that aligns with the groove 602 formed in the first structure 380 when the tamper resistant connector 310 according to this embodiment is installed on the plug 320. The groove 610 may serve as an alignment aid for properly positioning the second structure 382 and provides a space to accommodate the arm member 334 of the latch assembly 332 while the first structure 380 is in the engaged position and the second structure 382 is in the first position. Other than these differences, the configuration of the second structure 382 according to this embodiment is substantially similar to the second structure 382 according to the embodiment of FIG. 17 and thus will not be specifically repeated herein for brevity.

According to an exemplary embodiment, the equipment 12/312 and the connector assemblies 10/310 may be used on a materials handling vehicle 14, such as a forklift truck, see FIG. 24. The vehicle 14 may include a power source 16, such as a battery, and a controller 18 that communicates with various systems within the vehicle 14 in a conventional manner. The vehicle 14 illustrated in FIG. 24 includes exemplary equipment 12/312 of the type that may utilize the connector assemblies 10/310 disclosed herein. The equipment 12/312 may receive power from the vehicle 14 via the cable C in a conventional manner. The cable C may also provide communication between the equipment 12/312 and the controller 18 in a conventional manner.

Embodiments disclosed herein restrict access to, or actuation of, a connector latch assembly that is used to releasably couple a plug to a plug port of an equipment. Furthermore, fasteners used to secure the connector assembly increase the level of effort needed to gain access to the plug and connector pins, such that it takes an intentional act to defeat the connector assembly and gain that access to those pins.

The various features, aspects, and embodiments described herein can be used in any combination(s) with one another, or on their own.

Having thus described embodiments in detail, it will be apparent that modifications and variations are possible without departing from the scope of the appended claims.

What is claimed is:

1. A combination comprising:
a plug that provides a connection to an equipment, the plug comprising:
a front side for connection to a cable;
a back side for connection to the equipment; and
a latch assembly that is movable between a locked position in which the plug cannot be released from the equipment, and an unlocked position in which the plug can be released from the equipment; and
a tamper resistant connector assembly for restricting access to the latch assembly of the plug, the tamper resistant connector assembly comprising:
a first structure that is engageable with the plug proximate to the latch assembly, wherein the first structure restricts access to the latch assembly such that the latch assembly is not able to be moved from the locked position to the unlocked position when the first structure is engaged with the plug;
a second structure that is engageable with the first structure such that the first structure is not able to be disengaged from the plug when the second structure is engaged with the first structure; and
fastener structure for locking the second structure in engagement with the first structure.

2. The combination of claim 1, wherein the first and second structures are separate structures.

3. The combination of claim 1, wherein the first structure is removably engageable with the plug, wherein, when the first structure is not engaged with the plug, access to the latch assembly is permitted such that the latch assembly is able to be moved from the locked position to the unlocked position.

4. The combination of claim 1, wherein the second structure is lockably engageable to the first structure and the fastener structure lockably engages the second structure to the first structure.

5. The combination of claim 1, wherein the second structure is positionable in first and second positions relative to the first structure, the first position of the second structure comprising an attached position where the second structure is attached to the first structure and the second position of the second structure comprising a detached position where the second structure is detached from the first structure.

6. The combination of claim 5, wherein, when the fastener structure is locking the second structure in engagement to the first structure, the fastener structure is secured to the first structure and creates a stop that prevents the second structure from moving from the first position to the second position.

7. The combination of claim 5, wherein the second structure includes an extension portion for overlapping at least a part of the first structure while the second structure is in the first position, wherein the extension portion acts as a stop to prevent the first structure from being removed from the plug.

8. The combination of claim 7, wherein the first structure comprises a groove for receiving the extension portion.

9. The combination of claim 7, wherein the extension portion includes a lip for extending over a front face of the first structure to prevent the first structure from being disengaged from the plug.

10. The combination of claim 1, wherein the fastener structure is receivable in openings formed in the respective first and second structures.

11. The combination of claim 1, wherein the plug includes an attachment portion with an opening and the first structure includes an insertion portion for being received by the opening of the attachment portion of the plug.

12. The combination of claim 1, wherein the latch assembly comprises an arm member and the first structure comprises blocking structure for restricting access to the arm member.

13. The combination of claim 14, wherein the blocking structure comprises a pair of blocking elements that extend from a body portion of the first structure toward the plug on respective first and second lateral sides of the arm member when the first structure is engaged with the plug.

14. The combination of claim 1, wherein the first structure includes an insertion portion and the second structure comprises a notch for receiving the insertion portion of the first structure.

15. A tamper resistant connector assembly for selectively allowing and restricting access to a latch assembly of a plug that provides a connection to an equipment, the latch assembly being movable between a locked position in which the plug cannot be released from the equipment, and an unlocked position in which the plug can be released from the equipment, the tamper resistant connector assembly comprising:
a first structure that is removably engageable with the plug proximate to the latch assembly, wherein when the first structure is engaged with the plug, access to the latch assembly is restricted such that the latch assembly is not able to be moved from the locked position to the unlocked position, and when the first structure is not engaged with the plug, access to the latch assembly is permitted such that the latch assembly is able to be moved from the locked position to the unlocked position;
a second structure that is positionable in first and second positions relative to the first structure, wherein while the second structure is in the first position, the second structure is engaged with the first structure such that the first structure is not able to be disengaged from the plug, and while the second structure is in the second position, the first structure is able to be disengaged from the plug; and
fastener structure for selectively locking the second structure in the first position.

16. A tamper resistant connector assembly for selectively allowing and restricting access to a latch assembly of a plug that provides a connection to an equipment, the latch assembly being movable between a locked position in which the plug cannot be released from the equipment, and an unlocked position in which the plug can be released from the equipment, the tamper resistant connector assembly comprising:
a first structure that is removably engageable with the plug proximate to the latch assembly, wherein when the first structure is engaged with the plug, access to the latch assembly is restricted such that the latch assembly is not able to be moved from the locked position to the unlocked position, and when the first structure is not engaged with the plug, access to the latch assembly is permitted such that the latch assembly is able to be moved from the locked position to the unlocked position;
a second structure that is lockably engageable to the first structure such that the first structure is not able to be disengaged from the plug; and
fastener structure for lockably engaging the second structure to the first structure.

17. The tamper resistant connector assembly of claim 16, wherein the second structure is positionable in first and second positions relative to the first structure, wherein while the second structure is in the first position, the second structure is engaged with the first structure such that the first structure is not able to be disengaged from the plug, and while the second structure is in the second position, the first structure is able to be disengaged from the plug.

18. The tamper resistant connector assembly of claim 17, wherein the first position of the second structure comprises an attached position where the second structure is attached to the first structure and the second position of the second structure comprises a detached position where the second structure is detached from the first structure.

19. The tamper resistant connector assembly of claim 16, wherein, when the fastener structure is locking the second structure in engagement to the first structure, the fastener structure is secured to the first structure and creates a stop that prevents the second structure from moving from the first position to the second position.

20. A combination comprising a tamper resistant connector assembly according to claim 16 and further comprising:
a plug that provides a connection to an equipment, the plug comprising:
a front side for connection to a cable;
a back side for connection to the equipment; and
a latch assembly that is movable between a locked position in which the plug cannot be released from the equipment, and an unlocked position in which the plug can be released from the equipment.
